(19) United States
(12) Patent Application Publication
(10) Pub. No.: US 2012/0304543 A1
(43) Pub. Date: Dec. 6, 2012

(54) MOVABLE BARRIER SEAL ASSEMBLY

(76) Inventors: Danny L. Preising, JR., Massillon, OH (US); Charles A. Haba, Massillon, OH (US)

(21) Appl. No.: 13/150,937

(22) Filed: Jun. 1, 2011

(51) Int. Cl. E06B 7/23; E06B 7/16

(52) U.S. Cl. 49/495.1

(57) ABSTRACT

A seal assembly for an upward acting door that is positionable between an open and closed position. The seal assembly contains a base member having a first and second flexible sealing member extending therefrom for sealing engagement with the door. The base member is mounted adjacent the door to facilitate sliding engagement between the door and the first and second seal members as the door is moved between the open and closed positions.

### BACKGROUND

A typical garage door installation requires a gap between the garage door and the frame on a building to ensure unrestricted movement of the door when moving between the closed position and the open position. Unfortunately, such gaps can result in the infiltration of water, air, light and debris inside the garage along with thermal inefficiencies. In addition, such gaps result in unwanted lateral movement of the door, thus not only resulting in irritating noise, but creating rattling and movement that can potentially damage the door or building frame.

Various solutions have been tried to overcome these deficiencies. For example, door stops have been utilized to restrain the door from outward or lateral movement of the door when in the closed position. In addition, a weather seal is oftentimes used particularly in cold climates to seal the gap between the door frame and the perimeter of the door when the door is in the closed position. These weather seals resist airflow around the door and also prevent dirt and debris from entering the garage. However, there is a need to provide an improved seal design to reduce the infiltration of water, air, light and debris inside the garage along with the ability to minimize thermal inefficiencies and any unwanted and potentially damaging lateral movement of the door.

### SUMMARY

In accordance with the principles of the present invention, a seal assembly is provided for enclosing the gap formed between the door frame and the door that is vertically positionable between the door's open and closed position. The seal assembly includes a base member preferably coupleable to the door frame or other supporting structure adjacent the door and contains a first sealing member or wiper angularly extending from the base member and a second sealing member or bulb extending from the base member. The base member is mounted adjacent the door such that the wiper and bulb prevent light, water, debris and air infiltration into a garage. In addition, the bulb functions to resist lateral movement of the door when in the closed position or when transitioning between the open and closed positions. The wiper and bulb are preferably formed of a deflectable material such that as the door is moved between the open and closed positions, the movable barrier slideably engages the first and second sealing members.

### BRIEF DESCRIPTION OF THE DRAWINGS

FIG. 1 is an illustration of an upward acting door in which the seal assembly is employed to advantage of the present invention;

FIG. 2 is a plan view of the seal assembly of FIG. 1; and

FIG. 3 is a section view of the seal assembly depicted in FIGS. 1 and 2 taken along the section line 3-3 of FIG. 1.

### DETAILED DESCRIPTION

In the description which follows, like parts are marked throughout the specification and drawings with the same reference numerals, respectively. The drawings are not necessarily to scale and certain features may be shown exaggerated in scale or in somewhat schematic form in the interest of clarity and conciseness.

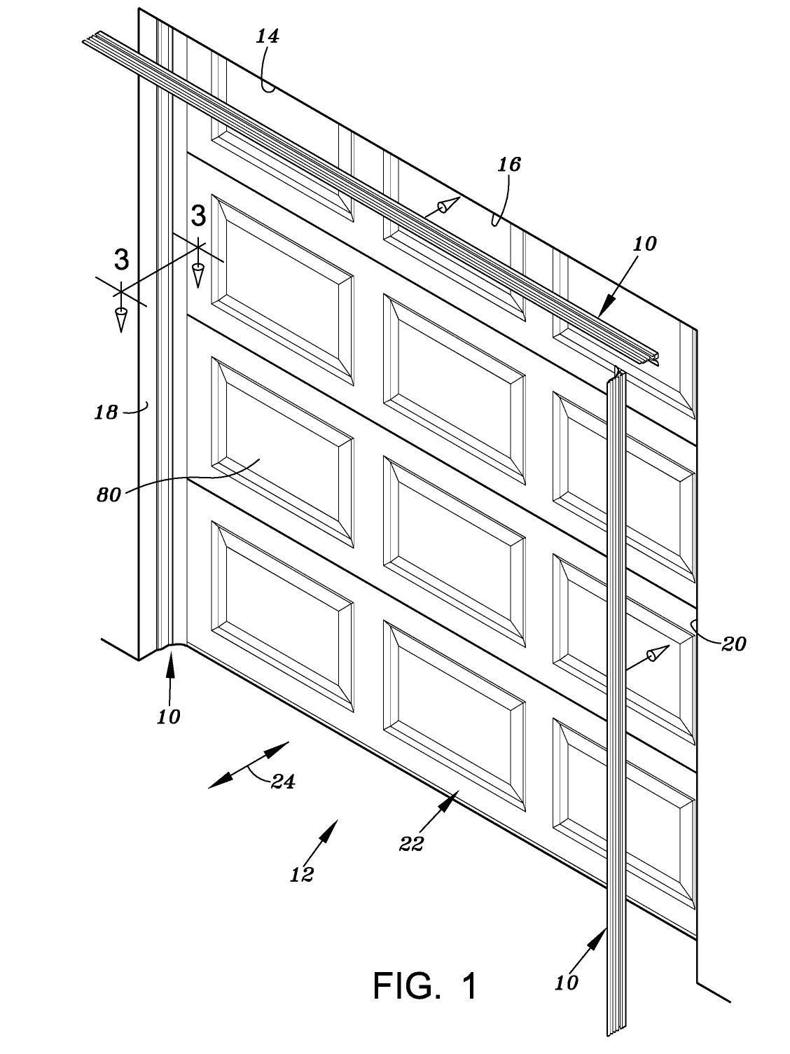

Referring initially to FIG. 1, a the seal assembly 10 employed that performs the dual function of providing a barrier seal and a barrier stop for an upward acting door 22, such as, for example, an upward acting sectional garage door. Specifically, seal assembly 10 is used for a garage 12 having an opening 14 formed by a top frame member 16 and side frame members 18 and 20. Preferably, seal assembly 10 is disposed overlying frame member 16 and side frame members 18 and 20 and is configured to form a seal between the door 22 and opening 14 formed by frame members 16, 18 and 20. In particular, seal assembly 10 functions to seal off, or otherwise prevent light, water, debris and/or air infiltration into, garage 12. In addition, the assembly functions as a stop so as to resist lateral movement of door 22 in the direction of arrows 24, which occurs because of pressure differences between the interior and exterior of the garage.

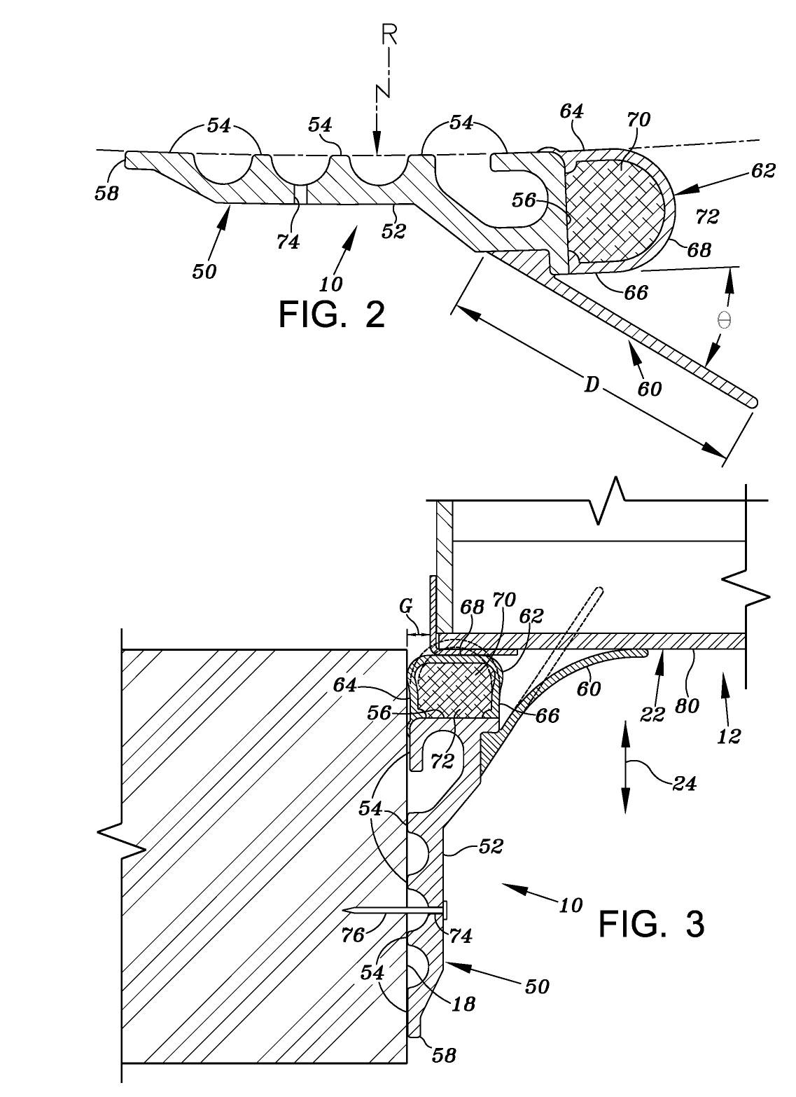

Referring now to FIG. 2, seal assembly 10 particularly comprises a base member 50 having a front surface 52, a rear surface 54, a top surface 56 and a bottom surface 58 for supporting a wiper or first seal member 60 and a bulb or second seal member 62. Wiper 60 angularly extends from base member 50 and is preferably formed of a flexible polymeric sheet, such as, for example, polyvinylchloride. However, it should be understood that wiper 60 may be formed of any flexible material. Preferably, wiper 60 extends for a short distance D, e.g., approximately 1.6 inches from and is mounted at an angle θ from the surface of door 22 of approximately 33 degrees; however, it should be understood that other values of D and θ can be used. In FIG. 1, bulb 62 extends from top surface 56 and is also formed of a flexible polymeric material, such as, for example, polyvinylchloride; however, it should be understood that bulb 62 may be otherwise formed of a material that is capable of deforming and/or otherwise flexing in order to sealingly seat against door 22. In the embodiment illustrated in FIG. 2, bulb 62 is formed of a continuous sheet material folded to form first and second legs 64 and 66 connected via an arcuate portion 68, which form an interior area 70. Optionally, interior area 70 may include an insulative material 72 disposed within interior area 70 to improve thermal resistance, as described in greater detail below.

Preferably, rear surface 54 is arcuately formed having a radius “R” to prevent or otherwise resist outward bowing or flexing of base member 50 as it is coupled to frames 16, 18 and/or 20. For example, in the embodiment illustrated in FIG. 2, base member 50 contains a pilot hole 74 to receive a fastener 76 (e.g., a nail or screw) for coupling to frame 16, 18 and/or 20. As fastener 76 secures base member 50 to frame 16, 18 and/or 20, the mid section of base member 50 is positioned toward and adjacent to the frame so as to preferably rest flush therewith to increase the sealing engagement with the frame and reducing the likelihood of the ends of the base member 50 (i.e., the portions of base member 50 near surface 56 and 58) lifting or otherwise separating from the frame.

Referring now to FIG. 3, it can be seen that the seal assembly 10 is positioned on frame member 18 to seal or otherwise enclose a gap G that is formed between frame member 18 and door 22. In particular, seal assembly 10 is coupled to frame member 18 such that wiper 60 and bulb 62 are deformed to be in sliding contact with an outer surface of face 80 of door 22 to enclose gap G, to thereby prevent light, water, debris and air from penetrating therethrough. In operation, bulb 62 is of a sufficient resiliency to function, not only as a seal, but as a door stop to prevent or substantially resist lateral movement of the door in the direction of arrows 24 (FIG. 3). Preferably, wiper 60 and bulb 62 are of a significant hardness durometer, preferably between 75 and 83. However, it should be understood that wiper 60 and bulb 62 may be otherwise formed to have a larger or smaller durometer.

The seal assembly 10 is preferably manufactured by co-extrusion so as to form a single unitary system consisting of rigid base member 50, flexible wiper 60 and flexible bulb 62. As illustrated in FIG. 2, wiper 60 and bulb 62 are in a non-deformed shape, such as when door 22 is in an open position. As illustrated in FIG. 3, wiper 60 and bulb 62 are deformed and positioned in sliding engagement with door 22.

Although embodiments of seal assembly 10 have been described in detail, those skilled in the art will also recognize that various substitutions and modifications may be made without departing from the scope and spirit of the invention, as defined solely by the appended claims.

What is claimed is:

1. A seal assembly for an upward acting door, the door positionable between an open and closed position, comprising:
a base member having a first and second flexible sealing member extending therefrom for sealing engagement with the door; and
wherein the base member is mounted adjacent the door to facilitate sliding engagement between the door and the first and second seal members as the barrier is moved between the open and closed positions.

2. The seal assembly of claim 1, wherein the first sealing member and base member are co-extruded into a single component.

3. The seal assembly of claim 1, wherein the base member and first and second sealing members are co-extruded into a single component.

4. The seal assembly of claim 1, wherein the base member is formed of a rigid polymer.

5. The seal assembly of claim 1, wherein the first and second sealing members are formed of a flexible polymer.

6. The seal assembly of claim 1, wherein the first seal is a wiper.

7. The seal assembly of claim 6, wherein the second seal is a bulb.

8. The seal assembly of claim 1, wherein the second seal member comprises a sufficient resiliency to reduce noise generated by the door by maintaining pressure against the door when in the closed position to resist lateral movement of the door.

9. The seal assembly of claim 1, wherein the base member is arcuate.

10. A seal assembly for enclosing a gap formed between an upward acting door and a building frame, the seal system comprising:
a base member having a front surface, a rear surface, a top surface and a bottom surface;
a first sealing member angularly extending from the front surface to slideably engage the movable barrier to enclose the gap; and
a second sealing member extending from the top surface and being of a sufficient resiliency to slideably engage the door to resist lateral movement of the door and enclose the gap.

11. The seal assembly of claim 10, wherein the base member is formed of a substantially rigid material.

12. The seal assembly of claim 10, wherein the rear surface is arcuate.

13. The seal assembly of claim 10, wherein the second sealing member comprises first and second legs connected by an arcuate portion.

14. The seal assembly of claim 13, wherein the first and second legs and arcuate portion form an interior area for receiving thermal insulation.

15. A seal assembly for an upward acting door, the door movable between an open position and a closed position, the assembly comprising:
a base member;
a flexible bulb extending from the base member to slideably engage a face of the door to resist lateral movement of the door; and
a wiper angularly extending from the base member to slideably engage the face of the door.

16. The seal assembly of claim 15, wherein the base member comprises an arcuate rear wall.

17. The seal assembly of claim 15, wherein the base member is formed of a rigid polymer.

18. The seal assembly of claim 15, wherein the wiper and bulb are formed of a flexible polymer.

19. The seal assembly of claim 15, wherein the bulb is formed of a sufficient resiliency to resist movement of the door by maintaining pressure against the door when in the closed position.

20. The seal assembly of claim 15, wherein the bulb comprises an interior area to receive thermal insulation.
